(19) United States
(12) Patent Application Publication
(10) Pub. No.: US 2016/0119834 A1
(43) Pub. Date: Apr. 28, 2016

(54) ADJUSTING CELL RESELECTION THRESHOLD

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/521,892

(22) Filed: Oct. 23, 2014

(51) Int. Cl. H04W 36/00; H04W 36/24

(52) U.S. Cl. CPC H04W 36/0094; H04W 36/24

(57) ABSTRACT

In a method and apparatus for wireless communication, reselection threshold are adjusted based whether a neighbor cell is an inter-frequency neighbor cell or an inter-radio access technology (IRAT) neighbor cell. A cell reselection serving cell threshold is an indicator for determining when to perform cell reselection. Cell reselection is performed in accordance with the cell reselection serving cell threshold.

### BACKGROUND

1. Field

Aspects of the present disclosure relate generally to wireless communication systems, and more particularly, to adjusting reselection thresholds based on inter-radio access technology (IRAT) neighbor measurements and inter-frequency neighbor measurements.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes determining whether to scale a cell reselection serving cell threshold based at least in part on whether a neighbor cell is an inter-frequency neighbor cell or an inter-radio access technology (IRAT) neighbor cell. The cell reselection threshold is an indicator for determining when to perform cell reselection. The method also includes performing cell reselection in accordance with the cell reselection serving cell threshold.

Another aspect discloses wireless communication having a memory and at least one processor coupled to the memory. The processor(s) is configured to determine whether to scale a cell reselection serving cell threshold based at least in part on whether a neighbor cell is an inter-frequency neighbor cell or an inter-radio access technology (IRAT) neighbor cell. The cell reselection threshold is an indicator for determining when to perform cell reselection. The processor is also configured to perform cell reselection in accordance with the cell reselection serving cell threshold.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of determining whether to scale a cell reselection serving cell threshold based at least in part on whether a neighbor cell is an inter-frequency neighbor cell or an inter-radio access technology (IRAT) neighbor cell. The cell reselection threshold is an indicator for determining when to perform cell reselection. The program code also causes the processor(s) to perform cell reselection in accordance with the cell reselection serving cell threshold.

Another aspect discloses an apparatus including means for determining whether to scale a cell reselection serving cell threshold based at least in part on whether a neighbor cell is an inter-frequency neighbor cell or an inter-radio access technology (IRAT) neighbor cell. The cell reselection threshold is an indicator for determining when to perform cell reselection. The apparatus also includes means for performing cell reselection in accordance with the cell reselection serving cell threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates a network utilizing multiple types of radio access technologies according to aspects of the present disclosure.

FIG. 5 illustrates a flow diagram for performing cell reselection according to aspects of the present disclosure.

FIG. 6 is a block diagram illustrating a method for performing cell reselection according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

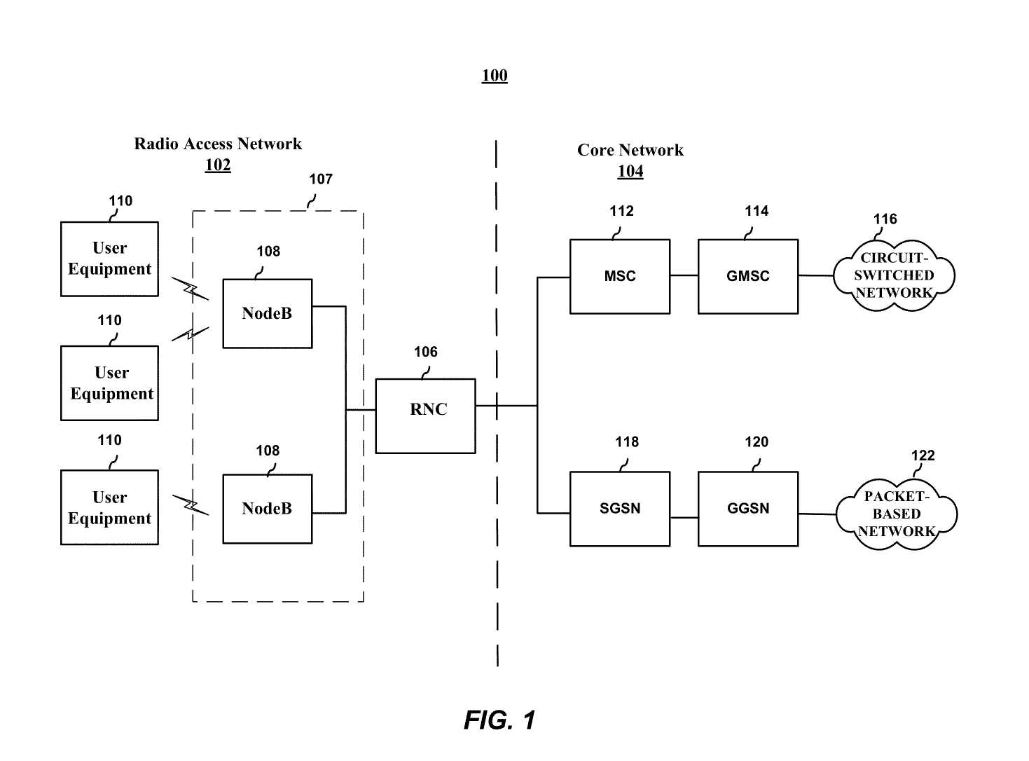

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

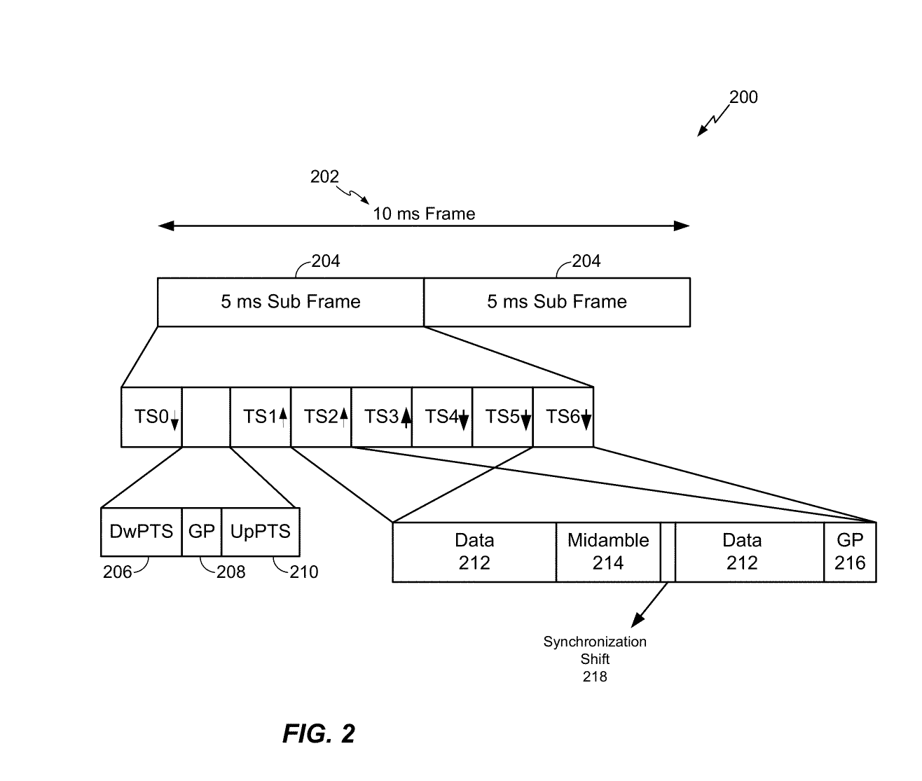

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

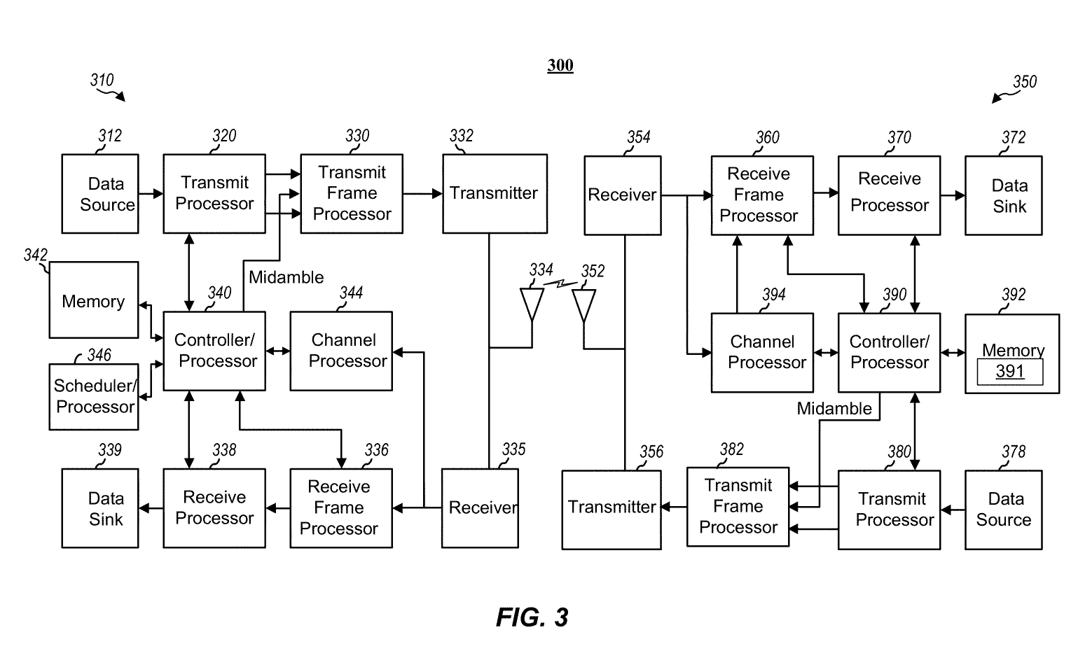

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memory 392 may store data and software for the UE 350, respectively. For example, the memory 392 of the UE 350 may store a reselection threshold module 391 which, when executed by the controller/processor 390, configures the UE 350 for determining whether to scale a reselection threshold.

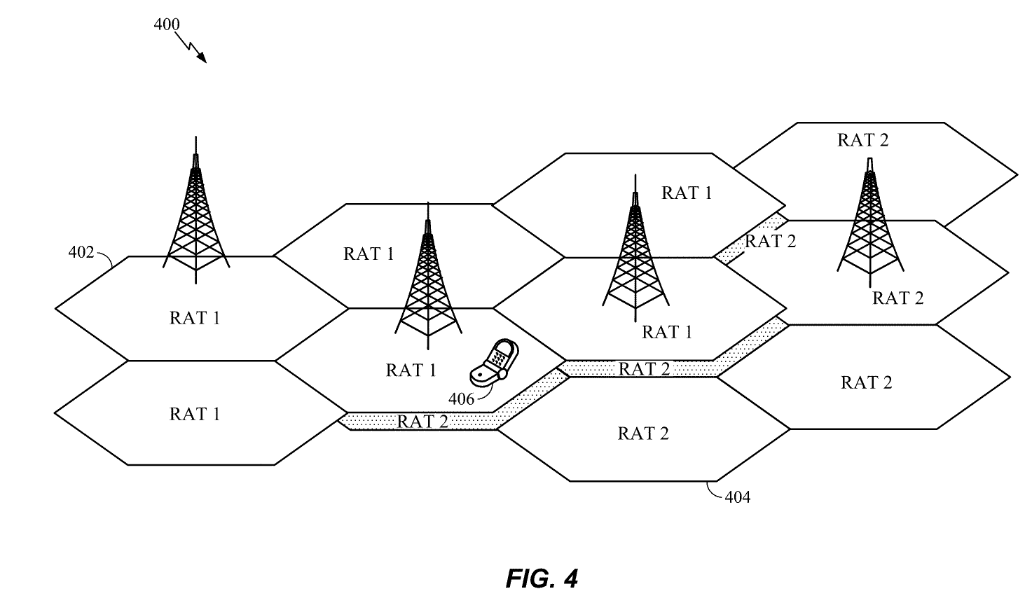

Some networks may be deployed with multiple radio access technologies. FIG. 4 illustrates a network utilizing multiple types of radio access technologies (RATs), such as but not limited to GSM (2G), TD-SCDMA (3G) and LTE (4G). Multiple RATs may be deployed in a network to increase capacity. Typically, 2G and 3G are configured with lower priority than 4G. Additionally, multiple frequencies within LTE (4G) may have equal of different priority configurations. Reselection rules are dependent upon defined RAT priorities. Different RATs are not configured with equal priority. In one example, the geographical area 400 includes RAT-1 cells 402 and RAT-2 cells 404. In one example, the RAT-1 cells are 2G or 3G cells and the RAT-2 cells are LTE cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., 2G/3G) a UE may be specified to perform a measurement of a neighboring cell (such LTE cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A network indicated cell reselection threshold determines when to reselect to other RATs of equal or lower priority (e.g., reselection from 4G to 3G/2G), and when to reselect to other LTE frequencies of equal or lower priority. Currently, the value of the cell reselection threshold is the same for reselection to other RATs and to other frequencies. In particular, the value of the cell reselection threshold is common for equal or lower priority LTE frequencies and lower priority RATS (e.g., 3G and 2G). When the signal quality of the serving cell is below the network indicated cell reselection threshold, the UE begins performing reselection evaluation procedures. The lower priority RATs (2G/3G) may have stronger signals due to overlay or co-site deployments. Accordingly, the 2G/3G neighbor cell(s) may have a signal quality above the reselection threshold value. The UE may then unnecessarily reselect to a 2G/3G neighbor instead of reselecting to an equal or lower priority LTE frequency. The term signal “quality” is intended to include any type of signal metric, such as, but not limited to the quality of a signal, the strength of a signal, etc.

Aspects of the present disclosure are directed to adjusting a threshold for determining when to perform cell reselection. In particular, in some circumstances the cell reselection threshold may be scaled based on signal quality so the UE can move to another LTE frequency rather than to an IRAT neighbor (e.g., a lower priority IRAT neighbor). For example, when a UE camps on a higher priority frequency, (e.g., LTE(4G)), the UE performs a cell reselection evaluation. The UE evaluates its inter-frequency neighbor cells (LTE(4G)) and also IRAT neighbor cells (2G and/or 3G). The cell reselection threshold may be adjusted when certain criteria are met. In particular, the cell reselection threshold may be scaled thereby allowing the UE to reselect to another LTE frequency.

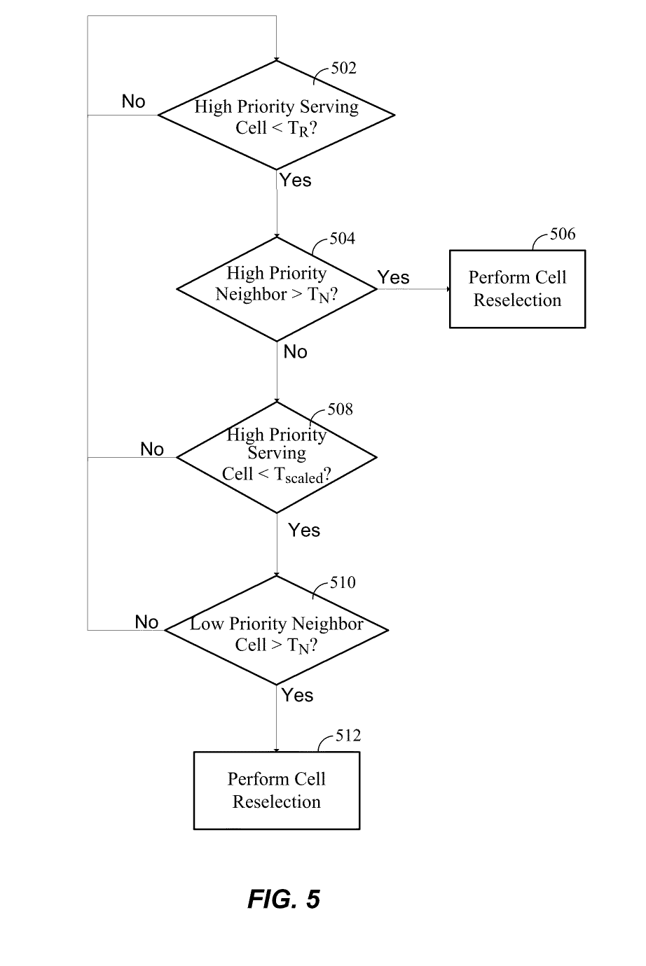

FIG. 5 is an example flow diagram 500 for performing cell reselection according to aspects of the present disclosure. The following example is with respect to 4G (LTE) as the high priority network and 2G/3G as the low priority network, although other networks are contemplated. First, at block 502, the UE checks the signal quality of the high priority serving cell to determine whether the signal quality is below a cell reselection threshold (where the threshold value is a non-scaled threshold value). The cell reselection threshold may be a network indicated threshold. If the serving cell signal quality is not below the cell reselection threshold (i.e., the serving cell signal quality is greater than the threshold value), then the UE returns to block 502 and does not perform cell reselection. As noted, the cell reselection threshold is not scaled. However, if the signal quality of the serving cell is determined to be below the cell reselection threshold (i.e., S_{LTE Serving}<T_{Reselection}), then the UE proceeds to block 504.

At block 504, the UE compares the signal quality of an LTE neighbor cell (i.e., inter-frequency neighbor cell) with a neighbor cell threshold. If the signal quality of the LTE neighbor cell is above the LTE neighbor cell threshold (i.e., S_{LTE Neighbor}>T_{Neighbor}), then cell reselection is performed at block 506 and the cell reselection threshold is maintained (e.g., the value of the threshold is not scaled). However, if the neighbor cell signal quality is not above the LTE neighbor cell threshold, the UE scales the cell reselection threshold (T_{ScaledReselection}) and proceeds to block 508. The amount the cell reselection threshold is scaled may be dependent on various factors, such as, but not limited to the serving cell signal quality and the signal quality of an equal or lower priority LTE frequency neighbor cell.

At block 508, the UE determines whether the LTE serving cell signal quality is below the scaled cell reselection threshold. If the signal quality is not below the scaled cell reselection value, the UE does not perform cell reselection and returns to block 502. Otherwise, if the UE determines the LTE serving cell signal quality is below the scaled cell reselection threshold (S_{LTE Serving}<T_{ScaledReselection}), the UE proceeds to block 510 to check the signal quality of an IRAT neighbor cell(s), (e.g. 2G, 3G neighbor cells). If the signal quality of the IRAT neighbor cell(s) is below the neighbor cell threshold, the UE does not perform cell reselection and returns to block 502. Otherwise, if the signal quality of the IRAT neighbor is above the neighbor threshold (i.e., S_{IRAT Neighbor}>T_{Neighbor}), the UE performs cell reselection to the neighbor at block 512. The neighbor threshold may be a scaled value. Alternately, the neighbor threshold is not a scaled value.

In one aspect, the cell reselection threshold is scaled when the neighbor cell is an IRAT neighbor cell. In another aspect, the reselection threshold is maintained (i.e., not scaled) for inter-frequency low priority neighbor cells. The scaling amount may be based on a difference between a serving cell signal strength and the signal strength of: an IRAT neighbor cell, an intra-frequency neighbor cell and/or an inter-frequency neighbor cell. Further, the scaling amount may be based on a priority difference between a serving cell and at least one of: an IRAT neighbor cell, an intra-frequency neighbor cell and an inter-frequency neighbor cell.

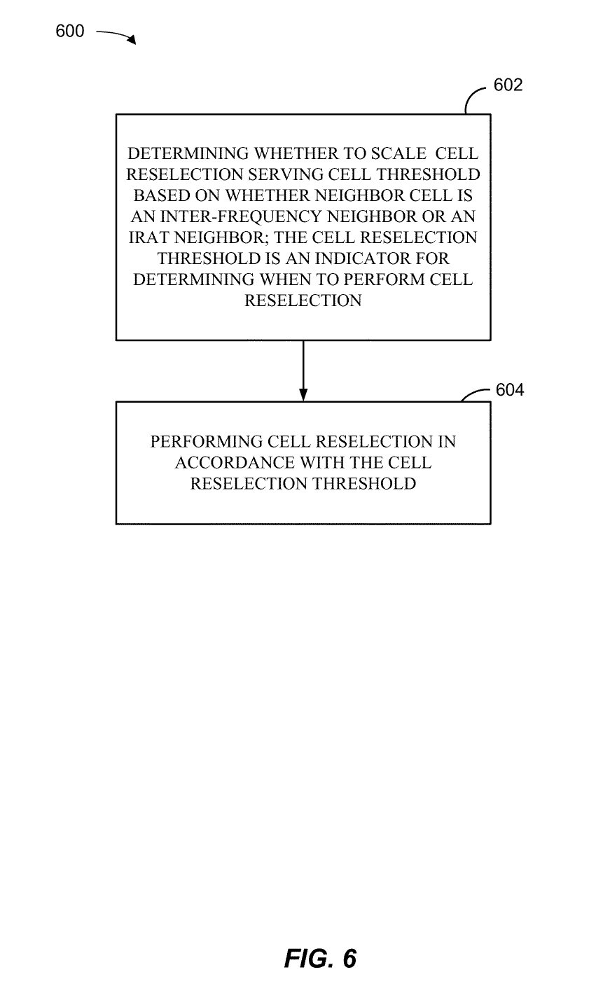

FIG. 6 shows a wireless communication method 600 according to one aspect of the disclosure. In block 602, a UE determines whether to scale a cell reselection serving cell threshold based on whether the neighbor cell is an inter-frequency neighbor cell or an IRAT neighbor cell. The cell reselection threshold is an indicator for determining when to perform cell reselection. In block 604, cell reselection is performed in accordance with the cell reselection threshold.

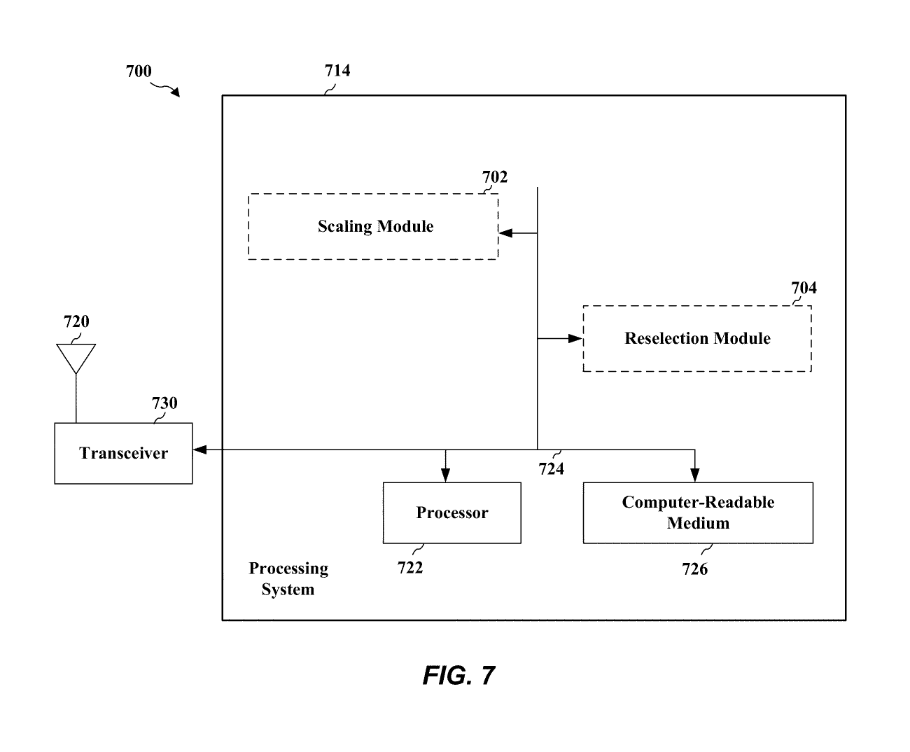

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a scaling module 702 for determining whether to scale a cell reselection threshold. The processing system 714 includes a reselection module 704 for performing cell reselection. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for determining. In one aspect, the determining means may be the antennas 352, the receiver 354, the channel processor 394, the receive frame processor 360, the receive processor 370, the controller/processor 390, the memory 392, reselection threshold module 391, scaling module 702, and/or the processing system 614 configured to perform the determining means. The UE is also configured to include means for performing. In one aspect, the performing means may be the antennas 352, the receiver 354, the channel processor 394, the receive frame processor 360, the receive processor 370, the transmitter 356, the transmit frame processor 382, the transmit processor 380, the controller/processor 390, the memory 392, reselection threshold module 391, reselection module 704, and/or the processing system 714 configured to perform the maintaining means. In another configuration, the aforementioned means may be any module or any apparatus configured to perform the functions recited by the aforementioned means.

Several aspects of a telecommunications system has been presented with reference to TD-SCDMA, GSM and LTE. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether to scale a cell reselection serving cell threshold based at least in part on whether a neighbor cell is an inter-frequency neighbor cell or an inter-radio access technology (IRAT) neighbor cell, the cell reselection serving cell threshold being an indicator for determining when to perform cell reselection; and
performing cell reselection in accordance with the cell reselection serving cell threshold.

2. The method of claim 1, further comprising scaling the cell reselection serving cell threshold for the IRAT neighbor cell.

3. The method of claim 2, in which performing comprises performing IRAT cell reselection when:
a high priority serving cell is below a scaled serving cell reselection threshold and a low priority IRAT neighbor cell is above a cell reselection neighbor cell threshold.

4. The method of claim 1, further comprising maintaining the cell reselection serving cell threshold for low priority inter-frequency neighbor cells.

5. The method of claim 4, in which performing comprises performing inter-frequency cell reselection when:
a high priority serving cell is below a non-scaled reselection threshold, and the neighbor cell is above a neighbor cell reselection threshold, where the neighbor cell is an inter-frequency neighbor cell.

6. The method of claim 1, further comprising scaling the cell reselection serving cell threshold by a scaling amount based at least in part on a serving cell signal quality.

7. The method of claim 1, further comprising scaling the cell reselection serving cell threshold by a scaling amount based at least in part on a signal quality of at least one of: the IRAT neighbor cell, an intra-frequency neighbor cell and an inter-frequency neighbor cell.

8. The method of claim 1, further comprising scaling the cell reselection serving cell threshold by a scaling amount based at least in part on a difference between a serving cell signal quality and the signal quality of at least one of: the IRAT neighbor cell, an intra-frequency neighbor cell and the inter-frequency neighbor cell.

9. The method of claim 1, in which a scaling amount is based at least in part on a priority difference between a serving cell and at least one of: the IRAT neighbor cell, and the inter-frequency neighbor cell.

10. An apparatus for wireless communication, comprising:
a memory; and
at least one processor coupled to the memory, the at least one processor being configured:
to determine whether to scale a cell reselection serving cell threshold based at least in part on whether a neighbor cell is an inter-frequency neighbor cell or an inter-radio access technology (IRAT) neighbor cell, the cell reselection serving cell threshold being an indicator for determining when to perform cell reselection; and
to perform cell reselection in accordance with the cell reselection serving cell threshold.

11. The apparatus of claim 10, further comprising scaling the cell reselection serving cell threshold for the IRAT neighbor cell.

12. The apparatus of claim 11, in which the at least one processor is further configured to performing IRAT cell reselection when:
a high priority serving cell is below a scaled serving cell reselection threshold and a low priority IRAT neighbor cell is above a cell reselection neighbor cell threshold.

13. The apparatus of claim 10, in which the at least one processor is further configured to maintain the cell reselection serving cell threshold for low priority inter-frequency neighbor cells.

14. The apparatus of claim 13, in which the at least one processor is configured to perform inter-frequency cell reselection when:
a high priority serving cell is below a non-scaled reselection threshold, and the neighbor cell is above a neighbor cell reselection threshold, where the neighbor cell is an inter-frequency neighbor cell.

15. The apparatus of claim 10, in which the at least one processor is further configured to scale the cell reselection serving cell threshold by a scaling amount based at least in part on a serving cell signal quality.

16. The apparatus of claim 10, in which the at least one processor is further configured to scale the cell reselection serving cell threshold by a scaling amount based at least in part on a signal quality of at least one of: the IRAT neighbor cell, an intra-frequency neighbor cell and an inter-frequency neighbor cell.

17. The apparatus of claim 10, in which the at least one processor is further configured to scale the cell reselection serving cell threshold by a scaling amount based at least in part on a difference between a serving cell signal quality and the signal quality of at least one of: the IRAT neighbor cell, an intra-frequency neighbor cell and the inter-frequency neighbor cell.

18. The apparatus of claim 10, in which a scaling amount is based at least in part on a priority difference between a serving cell and at least one of: the IRAT neighbor cell, and the inter-frequency neighbor cell.

19. A computer program product for wireless communication in a wireless network, comprising:
a non-transitory computer-readable medium having non-transitory program code recorded thereon, the program code comprising:
program code to determine whether to scale a cell reselection serving cell threshold based at least in part on whether a neighbor cell is an inter-frequency neighbor cell or an inter-radio access technology (IRAT) neighbor cell, the cell reselection serving cell threshold being an indicator for determining when to perform cell reselection; and
program code to perform cell reselection in accordance with the cell reselection serving cell threshold.

20. An apparatus for wireless communication, comprising:
means for determining whether to scale a cell reselection serving cell threshold based at least in part on whether a neighbor cell is an inter-frequency neighbor cell or an inter-radio access technology (IRAT) neighbor cell, the cell reselection serving cell threshold being an indicator for determining when to perform cell reselection; and
means for performing cell reselection in accordance with the cell reselection serving cell threshold.
